(19) United States
(12) Patent Application Publication
(10) Pub. No.: US 2026/0106305 A1
(43) Pub. Date: Apr. 16, 2026

(54) BATTERY POUCH CELLS IN A CAN

(71) Applicant: GM GLOBAL TECHNOLOGY OPERATIONS LLC, Detroit, MI (US)

(72) Inventors: Xianfeng Yan, Clawson, MI (US); Farah Al-Chalabi, Dearborn, MI (US); Robert H. Dietze, Brighton, MI (US); Jian Zhang, Rochester Hills, MI (US); Hunter Gilbert Rimatzki, Clawson, MI (US); Ryan Patrick Hickey, Austin, TX (US); Anthony Michael Coppola, Rochester Hills, MI (US)

(73) Assignee: GM GLOBAL TECHNOLOGY OPERATIONS LLC, Detroit, MI (US)

(21) Appl. No.: 18/912,440

(22) Filed: Oct. 10, 2024

(51) Int. Cl. H01M 50/291; H01M 50/211; H01M 50/30; H01M 50/516

(52) U.S. Cl. CPC H01M 50/291; H01M 50/211; H01M 50/394; H01M 50/516

(57) ABSTRACT

Disclosed is a plurality battery pouch cells received in a can, and including an end cap connected to the can, and more at least one of the can or end cap has vent holes formed therein.

### INTRODUCTION

The technical field generally relates to methods of coating steel components with a black oxide coating and products made thereby.

Heat from one battery pouch cell may propagate to adjacent battery pouch cells. The process of making battery pouch cells may require pouch cell tab trimming.

Accordingly, it is desirable to provide a design and method of assembly of a group of pouch cells to mitigate thermal propagation. It is desirable to reduce or eliminate the need to trim battery pouch cell tabs. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including: a first battery subsection including: a first battery pouch cell including a first pouch cell tab at a first end of the first battery pouch cell and a second pouch cell tab at a second end of the first battery pouch cell; a second battery pouch cell including a third pouch cell tab at a first end of the second battery pouch cell and a fourth pouch cell tab at a second end of the second battery pouch cell; a can housing including a top can section, a bottom can section, a first end cap and a second end cap, wherein the bottom can section defines a cavity; the first battery pouch cell and the second battery pouch cell received in the cavity: a first end cap connected to the bottom can section, the first end cap having a bus bar; and wherein the can housing has vent holes formed therein.

A number of variations may include a product wherein the first end cap includes a first end cap portion and a second end cap portion, and wherein the bus bar is embedded in the second end cap portion.

A number of variations may include a product wherein the first end cap has the vent holes formed therein.

A number of variations may include a product wherein the top can section has the vent holes formed therein.

A number of variations may include a product further including a nonconductive coating barrier including a first side wall a second side wall and a bottom side wall and a top wall that define a pocket therein, and wherein the first battery pouch cell and the second battery pouch cell are received in the pocket.

A number of variations may include a product wherein the nonconductive coating barrier includes a plurality of through holes formed in the top wall.

A number of variations may include a product further including a nonconductive cap having a through hole formed therein so that the first pouch cell tab and the third pouch cell tab may extend therethrough.

A number of variations may include a product further including an insulating foam material adjacent to the first battery pouch cell.

A number of variations may include a product wherein the first pouch cell tab and the third pouch cell tab are stacked together, bent over a portion of the second end cap portion, and welded to the bus bar.

A number of variations may include a product wherein the first pouch cell tab and the third pouch cell tab are stacked together and welded to the bus bar without bending over the second end cap portion.

A number of variations may include a product further including a second battery subsection including: a third battery pouch cell including a first pouch cell tab at a first end of the third battery pouch cell and a second pouch cell tab at a second end of the third battery pouch cell; and a fourth battery pouch cell including a third pouch cell tab at a first end of the fourth battery pouch cell and a fourth pouch cell tab at a second end of the fourth battery pouch cell.

A number of variations may include a product further including a mid-plug including a mid connector having a mid bus bar, and wherein the second pouch cell tab at the second end of the first battery pouch cell and the fourth pouch cell tab at the second end of the second battery pouch cell are welded to the mid bus bar, and wherein the first pouch cell tab at the first end of the third battery pouch cell and the third pouch cell tab at the second end of the fourth battery pouch cell are welded to the mid bus bar.

A number of variations may include a product wherein the top can section has the vent holes formed therein.

A number of variations may include a product further including a nonconductive coating barrier including a first side wall a second side wall and a bottom side wall and a top wall that define a pocket therein, and wherein the first battery pouch cell and the second battery pouch cell are received in the pocket.

A number of variations may include a product wherein the nonconductive coating barrier includes a plurality of through holes formed in the top wall.

A number of variations may include a product wherein the first end cap portion includes a first recess formed therein and wherein the bottom can section includes a first side wall and a second side wall spaced apart from the first side wall, wherein the first side wall includes a first flange extending towards the second side wall, and wherein the second side wall includes a second flange extending towards the first side wall, and wherein the first flange is received in the first recess in the first end cap portion, and wherein the second flange is received in a second recess formed and the second end cap portion.

A number of variations may include a product further including a second end cap including a first end cap portion and a second end cap portion, wherein the second end cap portion of the first end cap defines a first recess therein, and wherein the first end cap portion of the second end cap includes a projection received in the first recess.

A number of variations may include a product including: a first battery subsection including: a first battery pouch cell including a first pouch cell tab at a first end of the first battery pouch cell and a second pouch cell tab at a second end of the first battery pouch cell; a second battery pouch cell including a third pouch cell tab at a first end of the second battery pouch cell and a fourth pouch cell tab at a second end of the second battery pouch cell; a top can section and a bottom can section, the bottom can section defining a cavity; the first battery pouch cell and the second battery pouch cell received in the cavity: a first end cap connected to the bottom can section, the first end cap having a bus bar; at least one of the first end cap or the top can section having vent holes formed therein; wherein the first end cap includes a first end cap portion and a second end cap portion, and wherein the bus bar is embedded in the second end cap portion; and a nonconductive coating barrier including a first side wall, a second side wall spaced from the first side wall, a bottom side wall and a top wall that define a pocket therein, and wherein the first battery pouch cell and the second battery pouch cell are received in the pocket, wherein the first pouch cell tab and the third pouch cell tab are stacked together, bent over a portion of the second end cap portion, and welded to the bus bar, or the first pouch cell tab and the third pouch cell tab are stacked together and welded to the bus bar without bending over the second end cap portion.

A number of variations may include a system including: a first battery subsection including: a first battery pouch cell including a first pouch cell tab at a first end of the first battery pouch cell and a second pouch cell tab at a second end of the first battery pouch cell; a second battery pouch cell including a third pouch cell tab at a first end of the second battery pouch cell and a fourth pouch cell tab at a second end of the second battery pouch cell; a top can section and a bottom can section, the bottom can section defining a cavity; the first battery pouch cell and the second battery pouch cell received in the cavity: and a first end cap connected to the bottom can section, the first end cap having a bus bar; at least one of the first end cap or the top can section having vent holes formed therein.

A number of variations may include a system wherein the first end cap includes a first end cap portion and a second end cap portion, and wherein the bus bar is embedded in the second end cap portion, and wherein the first pouch cell tab and the third pouch cell tab are stacked together, bent over a portion of the second end cap portion, and welded to the bus bar, or the first pouch cell tab and the third pouch cell tab are stacked together and welded to the bus bar without bending over the second end cap portion.

### BRIEF DESCRIPTION OF THE DRAWINGS

The illustrative variations will hereinafter be described in conjunction with the following drawing figures, wherein like numerals denote like elements, and wherein:

FIG. 1A is an exploded, perspective view of a prismatic battery pouch cell short subsection according to a number of variations;

FIG. 1B is a perspective view of a prismatic battery pouch cell short subsection according to a number of variations;

FIG. 1C is a perspective view of a battery assembly including a plurality of prismatic battery pouch cell short subsections according to a number of variations;

FIG. 2 is an enlarged, partial view of the prismatic battery pouch cell assembly as shown in FIG. 1 according to a number of variations;

FIG. 3 is a perspective view of a plurality of pouch cells and a first set of the end cap portions at a first end of the plurality of pouch cells and a second set of end portions at a second end of the plurality of pouch cells according to a number of variations;

FIG. 4 is a partial, sectional view taken along line 4-4 in FIG. 3 showing bent tabs welded to a bus bar embedded a second portion of the first set of end cap portions according to a number of variations;

FIG. 5 is a perspective view of a plurality of pouch cells and a first set of the end cap portions at a first end of the plurality of pouch cells and a second set of end portions at a second end of the plurality of pouch cells according to a number of variations;

FIG. 6 is a partial, sectional view taken along line 6-6 in FIG. 5 showing unbent tabs welded to a bus bar embedded a second cap portion according to a number of variations;

FIG. 7 is an enlarged, partial view of the prismatic battery pouch cell assembly as shown in FIG. 3 according to a number of variations;

FIG. 8 is an enlarged, partial view of the prismatic battery pouch cell assembly as shown in FIG. 5 according to a number of variations;

FIG. 9A is an exploded, perspective view of a prismatic battery pouch cell double long subsection according to a number of variations;

FIG. 9B is a perspective view of a prismatic battery pouch cell double long subsection according to a number of variations;

FIG. 9C is a perspective view of a battery assembly including a plurality of prismatic battery pouch cell short subsections according to a number of variations;

FIG. 10 is an enlarged, partial view of a portion of FIG. 9A showing a main plug connecting a first prismatic battery pouch cell short subsection to a second prismatic battery pouch cell short section wherein the first prismatic battery pouch cell short subsection and second prismatic battery pouch cell short subsection each have a longitudinal axis in line with each other;

FIG. 11 is an enlarged, partial view of a portion of FIG. 9A;

FIG. 12 is a sectional view of section showing an end cap to can mechanical lock according to a number of variations; and

FIG. 13 is a sectional view of section showing an end cap to end cap mechanical lock according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

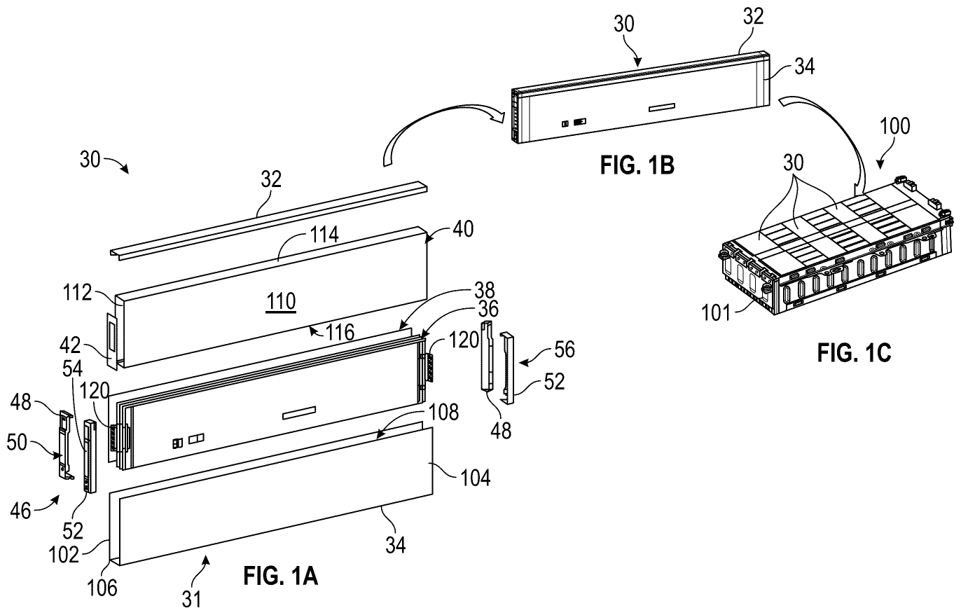

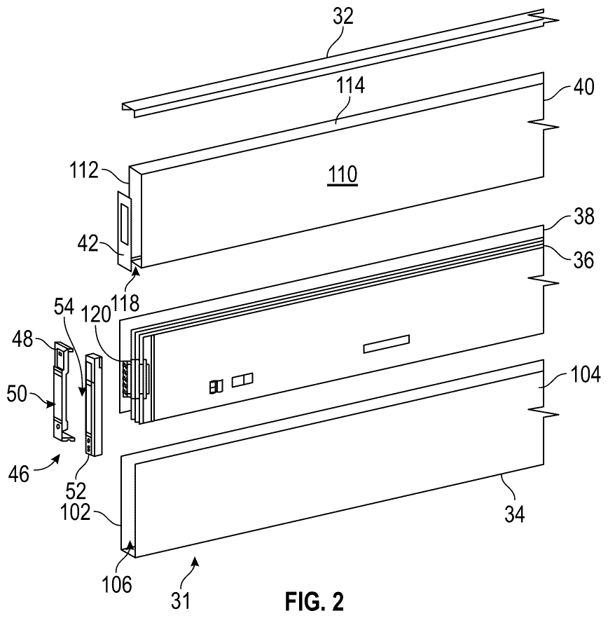

FIG. 1A is an exploded, perspective view of a prismatic battery pouch cell short subsection according to a number of variations. FIG. 1B illustrates the components of FIG. 1A assembled together as a prismatic battery pouch cell short section 30. FIG. 1C illustrates a plurality of the prismatic battery short subsections which may be operatively connected in a battery housing 101 to form a battery assembly 100. FIG. 2 is an enlarged, partial view of the prismatic battery pouch cell assembly as shown in FIG. 1 according to a number of variations. In a number of variations, for example as illustrated in FIGS. 1A, 1B, 1C, and 2, a prismatic battery pouch cell subsection 30 which may include a can housing 31, which may include a top can section 32, a bottom can section 34, a first end cap 46, and a second end cap 56. In a number of variations, the top can section 32 may be a continuous uniform solid construction and may not have any vent holes formed therein. The bottom can section 34 may include a first side wall 102 and a spaced apart second side wall 104. A bottom wall 106 may extend between the first side wall 102 and the second side wall 104 to define a can cavity 108. A first end cap 46 may include a first end cap portion 48 which may have a plurality of vent holes 50 formed therein, and a second end cap portion 52 may include a bus bar 54 embedded therein. A second end cap 56 may be similarly configured as the first end cap 46 and may include a first end cap portion 48 which may have a plurality of vent holes 50 formed therein, and a second end cap portion 52 may include a bus bar 54 embedded therein. A plurality of battery pouch cells 36 may be provided and an insulating foam material 38 may be provided adjacent to the plurality of pouch cells 36. A nonconductive coating barrier 40 may have a first side insulating wall 110, and opposite second side insulating wall 112, a top insulating wall 114, a bottom insulating wall 116, which may form a pocket 118 for receiving the plurality of pouch cells 36 and the foam material 38. A first end insulating wall 42 may be provided to cover the vent holes 50 and the bus bar 54 to isolate the subsection that is not in thermal runaway from neighboring section that is in thermal runaway.

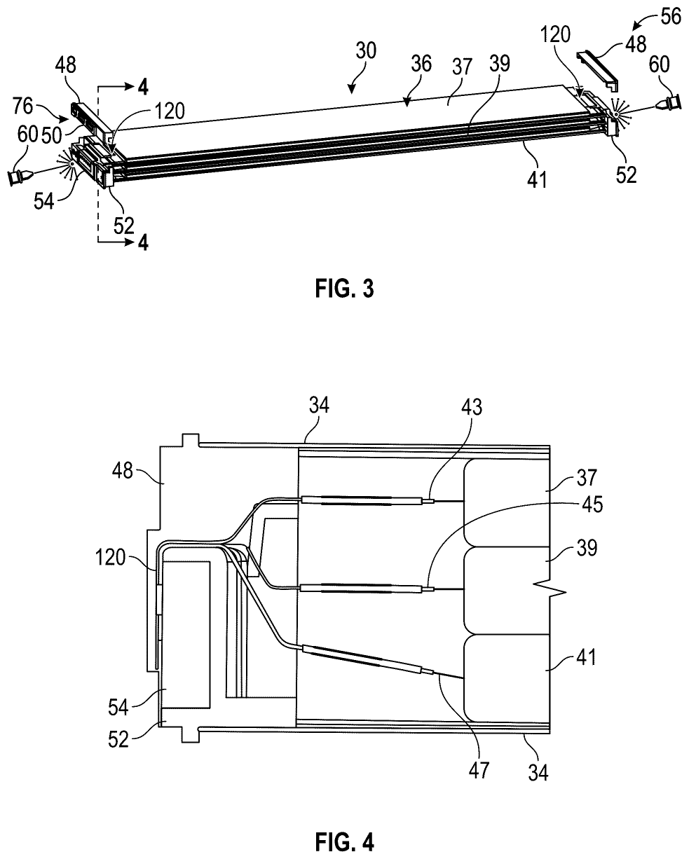

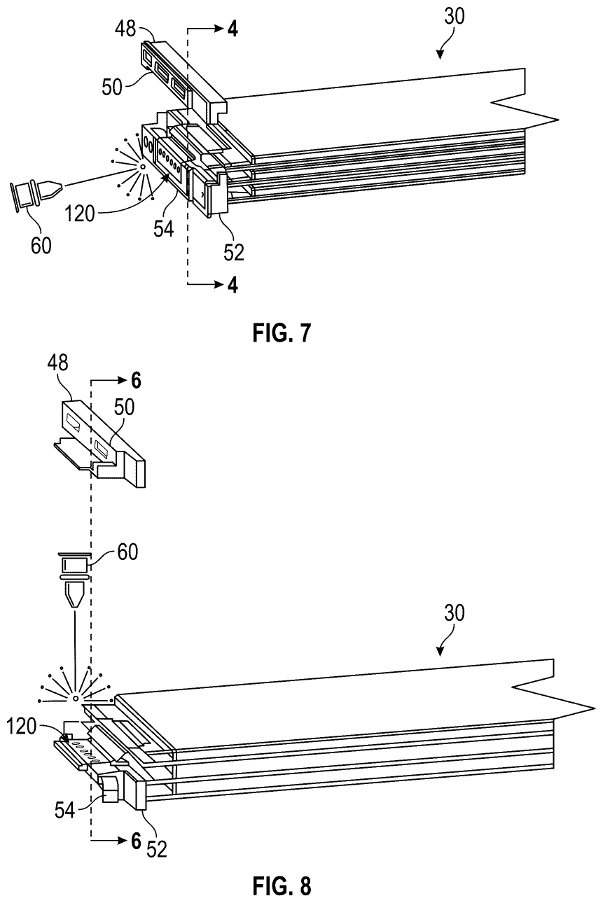

In a number of variations, for example as illustrated in FIGS. 3-4, and 7, the first end cap 46 and the second end cap 56 may be configured so that a plurality of pouch cell tabs 120 may be bent to engage a bus bar 54 embedded in the second end cap portion 52, and similarly a plurality of pouch cell tabs 120 may be bent to engage a bus bar 54 embedded in the second end cap portion 52 of the second end cap 56. The welding device 60 may be utilized to weld the plurality of pouch cell tabs 120 to the bus bar 54 in each of the first end cap 46 and the second end cap 56, respectively.

In a number of variations, for example as illustrated in FIG. 4, a first pouch cell 37 having a first pouch cell tab 43 may be stacked on a second pouch cell 39 having a second pouch cell tab 45, which in turn may be stacked on third pouch cell 41 having a third pouch cell tab 47. The first pouch cell tab 43, a second pouch cell tab 45, and the third pouch cell tab 47 may be stacked together and bent over the second end cap portion 52 so that the first pouch cell tab 43, a second pouch cell tab 45, and the third pouch cell tab 47 overlie the bus bar 54 embedded in the second end cap portion 52. Again, a welding device 60 may be utilized to weld the first pouch cell tab 43, a second pouch cell tab 45, and the pouch cell tab 47 to the bus bar 54. This enables the use of equal or different tab lengths without requiring pouch cell tab trimming.

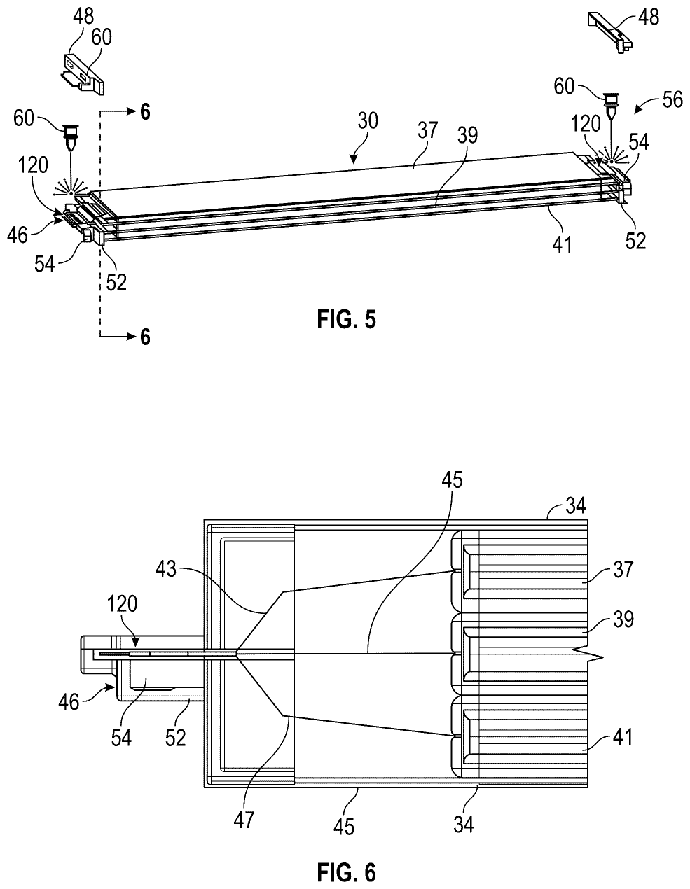

In a number of variations, for example as illustrated in FIGS. 5-6, and 8, the first end cap 46 and the second end cap 56 may be configured to eliminate the need for tab trimming or cell tab bending. Again, the first pouch cell 37 having the first pouch cell tab 43 may be stacked on the second pouch cell 39 having the second pouch cell tab 45, which in turn may be stacked on third pouch cell 41 having a third pouch cell tab 47. The first pouch cell tab 43, second pouch cell tab 45, and the third pouch cell tab 47 may be stacked on top of each other to overlie the bus bar 54 embedded in the second end cap portion 52 without having to bend the first pouch cell tab 43, second pouch cell tab 45, and third pouch cell tab 47 around the second end cap portion 52 or without bending the first pouch cell tab 43, second pouch cell tab 45, and third pouch cell tab 47 in a first end cap 46 or second end cap 56.

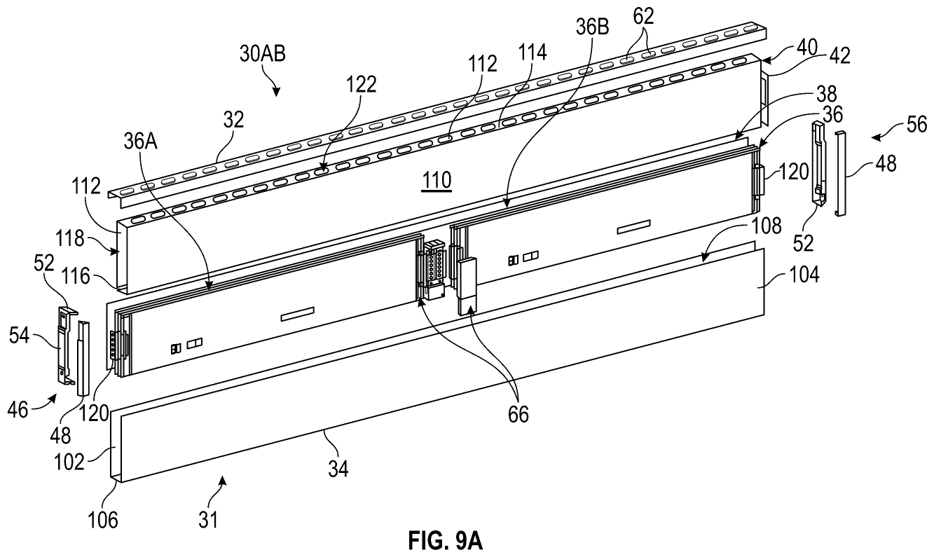

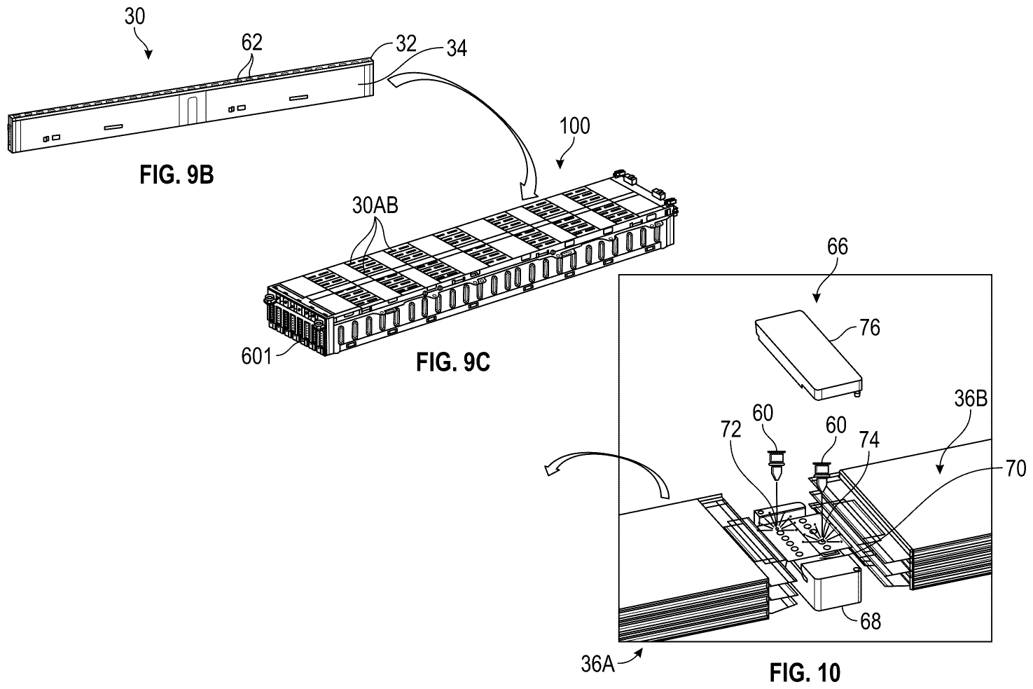

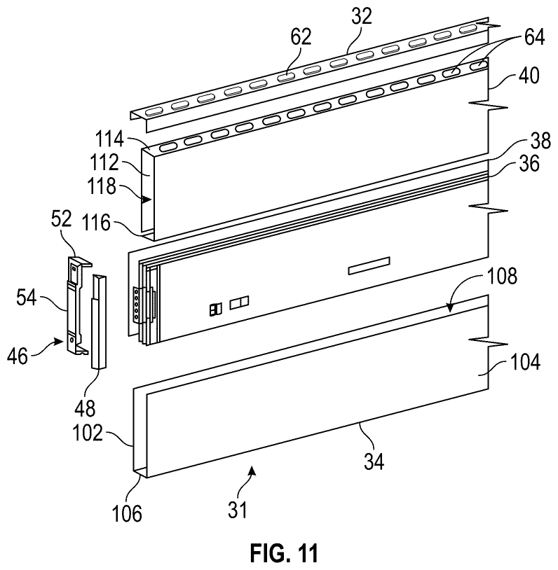

FIG. 9A is an exploded, perspective view of a prismatic battery pouch cell double long subsection according to a number of variations. FIG. 9B illustrates the components of FIG. 9A assembled together as a prismatic battery pouch cell double long section 30AB. FIG. 9C illustrates a plurality of the prismatic battery double long subsections which may be operatively connected in a battery housing 101 to form a battery assembly 100. FIG. 10 is an enlarged, partial view of the prismatic battery pouch cell double long subsection as shown in FIG. 9A according to a number of variations. FIG. 11 is an enlarged, partial view of a portion of FIG. 9A. In a number of variations, for example as illustrated in FIGS. 9A, 9B, 9C, 10 and 11, may include a prismatic battery pouch cell double long subsection 30AB, which may include a can housing 31, which may include a top can section 32, a bottom can section 34, a first end cap 46, and a second end cap 56. In a number of variations, the top can section 32 may a plurality of vent holes 122 formed therein. The bottom can section 34 may include a first side wall 102 and a spaced apart second side wall 104. A bottom wall 106 may extend between the first side wall 102 and the second side wall 104 to define a can cavity 108. A first end cap 46 may include a first end cap portion 48 which, in some variations, may not have a plurality of vent holes formed therein, and a second end cap portion 52 which may include a bus bar 54 embedded therein. A second end cap 56 may be similarly configured as the first end cap 46 and may include a first end cap portion 48 which, in some variations, may not have a plurality of vent holes formed therein, and a second end cap portion 52 which may include a bus bar 54 embedded therein. A first plurality of pouch cells 36A and a second plurality of pouch cells 36B may be provided. An insulating foam material 38 may be provided adjacent to the first plurality of pouch cells 36A and the second plurality of pouch cells 36B. A nonconductive coating barrier 40 may have a first side insulating wall 110, an opposite second side insulating wall 112, a top insulating wall 114, a bottom insulating wall 116, which may form a pocket 118 for receiving the first plurality of pouch cells 36A, the second plurality of pouch cells 36B, and the insulating foam material 38. A first end insulating wall 42, which may include a through hole 44 through which a plurality of pouch cell tabs 120 may extend.

A mid plug 66 may be provide so that the first plurality of pouch cells 36A may be operatively or electrically connected to the second plurality of pouch cells 36B. The mid plug 66 may include a mid bottom 68 having a mid bus bar 70 embedded therein. A first mid set of tabs 72 may be stacked together and welded, by a welding device 60, to the mid bus bar 70. A second mid set of tabs 72 may be stacked together and welded, by a welding device 60, to the mid bus bar 70. Thereafter, a mid cap 76 may be connected to the mid bottom 68.

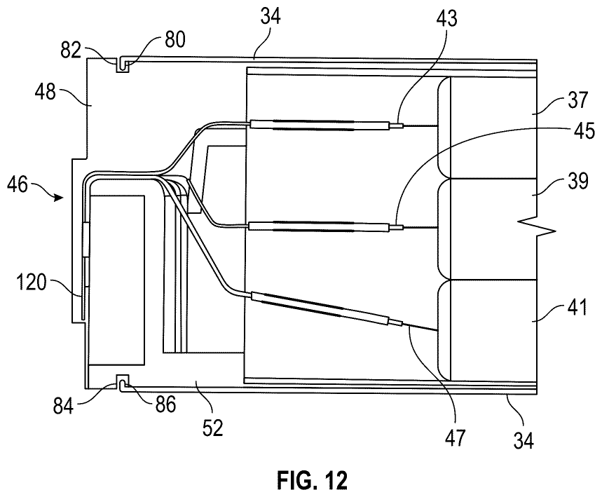

FIG. 12 illustrates a number of variations, which may include the bottom can section 34 including a first inwardly extending flange 84 received in a first recess 82 formed and the first end cap portion 48. The bottom can section 34 may include a second inwardly extending flange 86 received in a second recess 84 formed in the second end cap portion 52 of the first end cap 46.

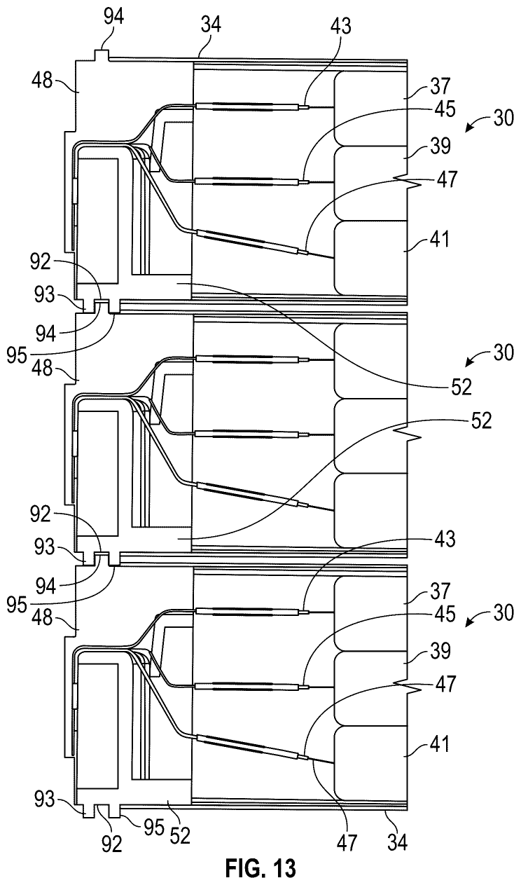

FIG. 13 illustrates a number of variations, which may include a first end cap portion 48 having a first projection 94 extending outwardly in a first direction. The second end cap portion 52 may recess 92 formed therein, for example, defined by a second projection 93 and a third projection 95 spaced a part of the second projection 93. Each of the second projection 93 and the third projection 95 of the second end cap portion 52 may extend a second direction which is opposite the first direction so that the first projection 94 may be received in the recess 92 to connect an adjacent subsections 30.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
a first battery subsection comprising:
a first battery pouch cell including a first pouch cell tab at a first end of the first battery pouch cell and a second pouch cell tab at a second end of the first battery pouch cell;
a second battery pouch cell including a third pouch cell tab at a first end of the second battery pouch cell and a fourth pouch cell tab at a second end of the second battery pouch cell;
a can housing comprising a top can section, a bottom can section, a first end cap and a second end cap, wherein the bottom can section defines a cavity;
the first battery pouch cell and the second battery pouch cell received in the cavity:
a first end cap connected to the bottom can section, the first end cap having a bus bar; and
wherein the can housing has vent holes formed therein.

2. The product as set forth in claim 1 wherein the first end cap includes a first end cap portion and a second end cap portion, and wherein the bus bar is embedded in the second end cap portion.

3. The product as set forth in claim 1 wherein the first end cap has the vent holes formed therein.

4. The product as set forth in claim 1 wherein the top can section has the vent holes formed therein.

5. The product as set forth in claim 1 further comprising a nonconductive coating barrier including a first side wall a second side wall and a bottom side wall and a top wall that define a pocket therein, and wherein the first battery pouch cell and the second battery pouch cell are received in the pocket.

6. The product as set forth in claim 5 wherein the nonconductive coating barrier includes a plurality of through holes formed in the top wall.

7. The product as set forth in claim 5 further comprising a nonconductive cap having a through hole formed therein so that the first pouch cell tab and the third pouch cell tab may extend therethrough.

8. The product as set forth in claim 5 further comprising an insulating foam material adjacent the first battery pouch cell.

9. The product as set forth in claim 2 wherein the first pouch cell tab and the third pouch cell tab are stacked together, bent over a portion of the second end cap portion, and welded to the bus bar.

10. The product as set forth in claim 2 wherein the first pouch cell tab and the third pouch cell tab are stacked together and welded to the bus bar without bending over the second end cap portion.

11. The product as set forth in claim 1 further comprising a second battery subsection comprising:
a third battery pouch cell including a first pouch cell tab at a first end of the third battery pouch cell and a second pouch cell tab at a second end of the third battery pouch cell; and
a fourth battery pouch cell including a third pouch cell tab at a first end of the fourth battery pouch cell and a fourth pouch cell tab at a second end of the fourth battery pouch cell.

12. The product as set forth in claim 11 further comprising a mid-plug including a mid connector having a mid bus bar, and wherein the second pouch cell tab at the second end of the first battery pouch cell and the fourth pouch cell tab at the second end of the second battery pouch cell are welded to the mid bus bar, and wherein the first pouch cell tab at the first end of the third battery pouch cell and the third pouch cell tab at the second end of the fourth battery pouch cell are welded to the mid bus bar.

13. The product as set forth in claim 12 wherein the top can section has the vent holes formed therein.

14. The product as set forth in claim 13 further comprising a nonconductive coating barrier including a first side wall a second side wall and a bottom side wall and a top wall that define a pocket therein, and wherein the first battery pouch cell and the second battery pouch cell are received in the pocket.

15. The product as set forth in claim 14 wherein the nonconductive coating barrier includes a plurality of through holes formed in the top wall.

16. The product as set forth in claim 2 wherein the first end cap portion includes a first recess formed therein and wherein the bottom can section comprises a first side wall and a second side wall spaced apart from the first side wall, wherein the first side wall includes a first flange extending towards the second side wall, and wherein the second side wall includes a second flange extending towards the first side wall, and wherein the first flange is received in the first recess in the first end cap portion, and wherein the second flange is received in a second recess formed and the second end cap portion.

17. The product as set forth in claim 11 further comprising a second end cap comprising a first end cap portion and a second end cap portion, wherein the second end cap portion of the first end cap defines a first recess therein, and wherein the first end cap portion of the second end cap includes a projection received in the first recess.

18. A product comprising:
a first battery subsection comprising:
a first battery pouch cell including a first pouch cell tab at a first end of the first battery pouch cell and a second pouch cell tab at a second end of the first battery pouch cell;
a second battery pouch cell including a third pouch cell tab at a first end of the second battery pouch cell and a fourth pouch cell tab at a second end of the second battery pouch cell;
a top can section and a bottom can section, the bottom can section defining a cavity;
the first battery pouch cell and the second battery pouch cell received in the cavity:
a first end cap connected to the bottom can section, the first end cap having a bus bar;
at least one of the first end cap or the top can section having vent holes formed therein;
wherein the first end cap includes a first end cap portion and a second end cap portion, and wherein the bus bar is embedded in the second end cap portion; and
a nonconductive coating barrier including a first side wall, a second side wall spaced from the first side wall, a bottom side wall and a top wall that define a pocket therein, and wherein the first battery pouch cell and the second battery pouch cell are received in the pocket,
wherein the first pouch cell tab and the third pouch cell tab are stacked together, bent over a portion of the second end cap portion, and welded to the bus bar, or the first pouch cell tab and the third pouch cell tab are stacked together and welded to the bus bar without bending over the second end cap portion.

19. A system comprising:
a first battery subsection comprising:
a first battery pouch cell including a first pouch cell tab at a first end of the first battery pouch cell and a second pouch cell tab at a second end of the first battery pouch cell;
a second battery pouch cell including a third pouch cell tab at a first end of the second battery pouch cell and a fourth pouch cell tab at a second end of the second battery pouch cell;
a top can section and a bottom can section, the bottom can section defining a cavity;
the first battery pouch cell and the second battery pouch cell received in the cavity: and
a first end cap connected to the bottom can section, the first end cap having a bus bar;
at least one of the first end cap or the top can section having vent holes formed therein.

20. The system as set forth in claim 19 wherein the first end cap includes a first end cap portion and a second end cap portion, and wherein the bus bar is embedded in the second end cap portion, and wherein the first pouch cell tab and the third pouch cell tab are stacked together, bent over a portion of the second end cap portion, and welded to the bus bar, or the first pouch cell tab and the third pouch cell tab are stacked together and welded to the bus bar without bending over the second end cap portion.
